(19) United States
(12) Patent Application Publication
(10) Pub. No.: US 2009/0002733 A1
(43) Pub. Date: Jan. 1, 2009

(54) PRINTING APPARATUS, CONTROL METHOD THEREFOR, PROGRAM, AND STORAGE MEDIUM

(75) Inventor: Nobuyoshi Kakigi, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/138,069

(22) Filed: Jun. 12, 2008

(30) Foreign Application Priority Data
Jun. 13, 2007 (JP) 2007-156436

(51) Int. Cl. G06K 1/00; G06F 3/12

(52) U.S. Cl. 358/1.9; 358/1.15

(57) ABSTRACT

A printing apparatus which is capable of carrying out proxy printing by a simple operation of attaching a removable storage medium, while preventing an erroneous operation without complicating an operation for selecting a function from various functions for use with the removable storage medium. The printing apparatus prints out print data stored in a storage device. When the printing apparatus cannot print out the print data stored in the storage device, print data stored in the storage unit and yet to be subjected to print processing is transferred into the external memory in response to attachment of the external memory to the printing apparatus. When the printing apparatus can print out the print data stored in the storage device, a job is executed using the external memory in response to attachment of the external memory to the printing apparatus.

### BACKGROUND OF THE INVENTION

1. Field of the Invention

The present invention relates to a printing apparatus, a control method therefor, a program, and a storage medium, and more particularly to a printing apparatus having a function related to a removable memory medium, a control method therefor, a program for implementing the control method, and a storage medium storing the program.

2. Description of the Related Art

Conventionally, Japanese Patent Laid-Open Publication (Kokai) No. H04-306060 has proposed a technique described below, so as to cope with a case where a printing apparatus, such as a facsimile machine, for printing a received image cannot execute printing due to run-out of sheets or failure of a recording system.

More specifically, there has been proposed a system configured to cause, when such a trouble as mentioned above occurs, an image data communication apparatus to store image data in a floppy (registered trademark) disk medium which is removably set therein and is free from data corruption even when removed therefrom, and cause another printing apparatus having a normal recording system to print the image data.

However, the above-mentioned prior art suffers from a problem described below.

The removable storage medium has the range of its use expanded, and can not only be used for achieving such an alternative function as described above when the above-mentioned error has occurred, but also can perform various functions triggered when it is attached.

For example, these are the direct printing function for printing data stored in a storage medium, and the Scan-to-USB memory function for storing an image read by a scanner into a removable storage medium. Further, there are the firmware update function for starting downloading firmware of a printing apparatus stored in a USB flash drive (USB memory card or stick) when the USB flash drive is attached, to thereby upgrade the version of the firmware, the user environment saving function for saving configuration values of a printing apparatus into a USB flash drive, and the print data saving function for saving print data from a printing apparatus in which an error has occurred.

Therefore, the removable storage medium has come to be used in printing apparatuses, for various uses. For this reason, a printing apparatus is required to correctly determine the intended use of a removable storage medium attached thereto, and provide control so as to prevent an erroneous operation. To do so, however, the user has to select a function for the intended use whenever the storage medium is attached to the printing apparatus, which complicates the user operation of the printing apparatus.

Particularly in LBPs (Laser Beam Printers) with a simple UI (User Interface), an increase in the number of user operations brings about the inconvenience of degraded operability, and on the other hand, the mounting of a multifunction UI causes an increase in costs. Therefore, the increase in the number of user operations and the mounting of the multifunction US should be avoided.

### SUMMARY OF THE INVENTION

The present invention provides a printing apparatus which is capable of carrying out proxy printing by a simple operation of attaching a removable storage medium (external memory), while preventing an erroneous operation without complicating an operation for selecting a function from various functions for use with the removable storage medium, a control method therefor, a program for implementing the control method, and a storage medium storing the program.

In a first aspect of the present invention, there is provided a printing apparatus to which an external memory is removably attachable, comprising a printing unit configured to print out print data stored in a storage unit, a transfer unit configured to be operable when the printing unit cannot print out the print data stored in the storage unit, to transfer print data stored in the storage unit and yet to be subjected to print processing into the external memory in response to attachment of the external memory to the printing apparatus, and an execution unit configured to be operable when the printing unit can print out the print data stored in the storage unit, to execute a job using the external memory in response to attachment of the external memory to the printing apparatus.

With the arrangement of the first aspect of the present invention, it is possible to cause the printing apparatus to carry out proxy printing by a simple operation of attaching a removable storage medium, while preventing an erroneous operation without complicating an operation for selecting a function from various functions for use with the removable storage medium (external memory).

In a second aspect of the present invention, there is provided a printing apparatus to which an external memory is removably attachable, comprising a detection unit configured to detect a state of the printing apparatus, a check unit configured to check contents of data stored in the external memory attached to the printing apparatus, a determination unit configured to determine a processing operation to be carried out, based on the state of the printing apparatus detected by the detection unit and the contents of the data stored in the external memory and checked by the check unit, from a plurality of processing operations that can be executed by the printing apparatus using the external memory, and an execution unit configured to carry out the processing operation determined by the determination unit.

In a third aspect of the present invention, there is provided a control method for a printing apparatus to which an external memory is removably attachable, comprising a printing step of printing out print data stored in a storage unit, a transfer step of transferring, when the print data stored in the storage unit cannot be printed out in the printing step, print data stored in the storage unit and yet to be subjected to print processing into the external memory in response to attachment of the external memory to the printing apparatus, and an execution step of executing, when the print data stored in the storage unit can be printed out in the printing step, a job using the external memory in response to attachment of the external memory to the printing apparatus.

In a fourth aspect of the present invention, there is provided a control method for a printing apparatus to which an external memory is removably attachable, comprising a detection step of detecting a state of the printing apparatus, a check step of checking contents of data stored in the external memory attached to the printing apparatus, a determination step of determining a processing operation to be carried out, based on the state of the printing apparatus detected in the detection step and the contents of the data stored in the external memory and checked in the check step, from a plurality of processing operations that can be executed by the printing apparatus using the external memory, and an execution step of carrying out the processing operation determined in the determination step.

In a fifth aspect of the present invention, there is provided a control program for causing a printing apparatus to which an external memory is removably attachable to execute a control method for the printing apparatus, wherein the control method comprises a printing step of printing out print data stored in a storage unit, a transfer step of transferring, when the print data stored in the storage unit cannot be printed out in the printing step, print data stored in the storage unit and yet to be subjected to print processing into the external memory in response to attachment of the external memory to the printing apparatus, and an execution step of executing, when the print data stored in the storage unit can be printed out in the printing step, a job using the external memory in response to attachment of the external memory to the printing apparatus.

In a sixth aspect of the present invention, there is provided a control program for causing a printing apparatus to which an external memory is removably attachable to execute a control method for the printing apparatus, wherein the control method comprises a detection step of detecting a state of the printing apparatus, a check step of checking contents of data stored in the external memory attached to the printing apparatus, a determination step of determining a processing operation to be carried out, based on the state of the printing apparatus detected in the detection step and the contents of the data stored in the external memory and checked in the check step, from a plurality of processing operations that can be executed by the printing apparatus using the external memory, and an execution step of carrying out the processing operation determined in the determination step.

In a seventh aspect of the present invention, there is provided a storage medium storing, in a computer-readably manner, a program for causing a computer to execute a control program for causing a printing apparatus to which an external memory is removably attachable to execute a control method for the printing apparatus, wherein the control method comprises a printing step of printing out print data stored in a storage unit, a transfer step of transferring, when the print data stored in the storage unit cannot be printed out in the printing step, print data stored in the storage unit and yet to be subjected to print processing into the external memory in response to attachment of the external memory to the printing apparatus, and an execution step of executing, when the print data stored in the storage unit can be printed out in the printing step, a job using the external memory in response to attachment of the external memory to the printing apparatus.

In an eighth aspect of the present invention, there is provided a storage medium storing, in a computer-readably manner, a program for causing a computer to execute a control program for causing a printing apparatus to which an external memory is removably attachable to execute a control method for the printing apparatus, wherein the control method comprises a detection step of detecting a state of the printing apparatus, a check step of checking contents of data stored in the external memory attached to the printing apparatus, a determination step of determining a processing operation to be carried out, based on the state of the printing apparatus detected in the detection step and the contents of the data stored in the external memory and checked in the check step, from a plurality of processing operations that can be executed by the printing apparatus using the external memory, and an execution step of carrying out the processing operation determined in the determination step.

The features and advantages of the invention will become more apparent from the following detailed description taken in conjunction with the accompanying drawings.

### BRIEF DESCRIPTION OF THE DRAWINGS

FIG. 1 is a diagram useful in explaining how proxy printing is performed when a USB flash drive is attached to a printing system including a printing apparatus according to an embodiment of the present invention.

FIG. 2 is a functional block diagram of a printer (printing apparatus) appearing in FIG. 1.

FIG. 3 is a view of the construction of the printer.

FIG. 4 is a block diagram of a video controller appearing in FIG. 2.

FIG. 5 is a diagram showing blocks constituting a printer engine appearing in FIG. 2 and signal lines between the video controller and the printer engine.

FIGS. 6A and 6B are diagrams useful in explaining the structure of information to be stored in an external memory appearing in FIG. 2.

FIG. 7 is a flowchart of an external memory attachment-responsive process executed by the video controller in FIG. 4.

FIG. 8 is a flowchart of an unrecoverable error-time process executed in a step S705 in FIG. 7.

FIGS. 9A to 9C are a flowchart of a recoverable error-time process executed in a step S706 in FIG. 7.

FIGS. 10A to 10C are a flowchart of a normal-state process that is executed in a step S707 in FIG. 7.

### DETAILED DESCRIPTION OF THE EMBODIMENTS

The present invention will now be described in detail with reference to the drawings showing a preferred embodiment thereof.

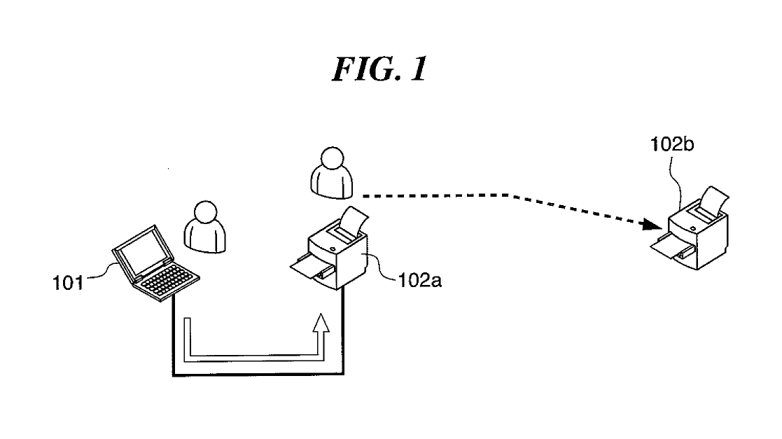

FIG. 1 is a diagram useful in explaining how proxy printing is performed when a USB flash drive is attached to a printing system including a printing apparatus according to the embodiment of the present invention.

Referring to FIG. 1, the printing system is formed by interconnecting a data processing apparatus 101 implemented by a client PC and a plurality of printing apparatuses (printers) 102 (102a and 102b) via a network. It should be noted that the printer 102b may not necessarily be connected to the network.

FIG. 1 shows a situation in which a user who issued a print instruction to the printer 102a from the data processing apparatus 101 comes to the printer 102a to get a printout therefrom, only to find that printing has not been completed due to occurrence of an error. In this case, a job transmitted from the data processing apparatus 101 to the printer 102a remains stored in a storage device within the printer 102a. It should be noted that the term “job” used in the present embodiment indicates print data and information required for print processing to be executed based on the print data.

In the above-mentioned situation, the user conventionally cancels the error and then restarts printing by the printer 102a. However, for example, when specified sheets have run out and there are no spare sheets, or when the printer cannot continue printing due to a failure or the like, it is impossible for the user to eliminate the error and continue printing, and therefore it is more efficient to carry out printing using another printer.

Further, in a case where an abnormal operation of a printer causes paper jam repeatedly each time printing operation is restarted, even if an error is cancelled, the same error occurs. Therefore, it is more efficient to carry out printing using another printer.

According to the present embodiment, in the above-mentioned situation, the job stored in the printer 102a is saved into a USB flash drive by a simple operation of inserting the USB flash drive prepared for job saving into the printer 102a. The term “saving” used in the present embodiment means “to transfer a job stored in a printer 102 into a USB flash drive”. After a job stored in a printer 102 is saved into a USB flash drive, the job in the printer 102 may be either deleted or left therein without being deleted. In a case where a job is left in a printer 102 without being deleted, the term “saving” means “to copy the job into a USB flash drive”.

A job thus transferred from a printer into an external memory, such as a USB flash drive, for proxy printing to be executed by another printer is referred to as “a saved job”.

The USB flash drive having the job saved therein is inserted into the other printer 102b so as to continue printing. In order to get the USB flash drive ready for saving the job, it is necessary to register the same user ID as one written in the job into the USB flash drive in advance. Registration of a user ID can be performed either by inserting a USB flash drive into the data processing apparatus 101 and using an application stored in the data processing apparatus 101, or by inserting the USB flash drive into a printer 102 and using a UI of the printer 102.

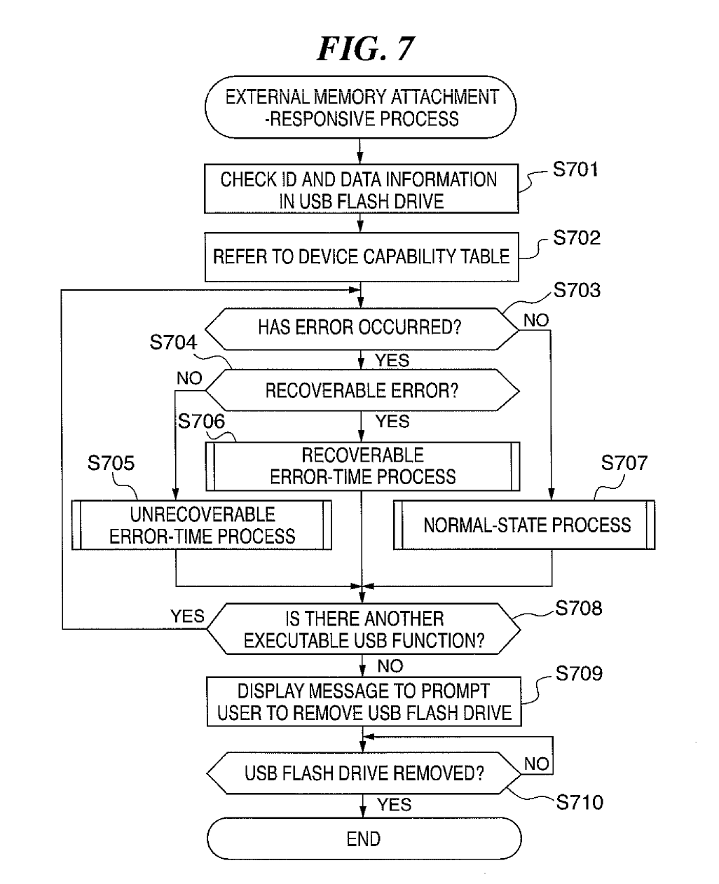

Although in the present embodiment, the external memory is implemented by a USB flash drive (USB memory card or stick), another kind of removable memory, such as an SD® card or a Memory Stick®, may be used as the external memory. The above described operation will be described in more detail hereinafter with reference to flowcharts in FIG. 7 et sec.

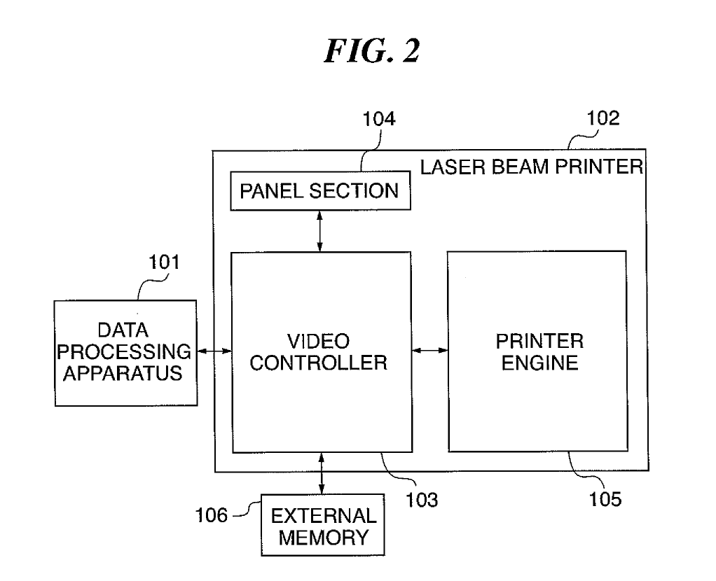

FIG. 2 is a functional block diagram of a printer appearing in FIG. 1.

Referring to FIG. 2, the data processing apparatus 101 is implemented by a computer as described hereinabove, and functions as a print data supply source or as a control apparatus for controlling the printer(s) 102. In the present embodiment, each printer 102 is implemented by a laser beam printer.

The printing apparatus according to the present embodiment is not limited to a laser beam printer, but it may be a copying machine, a facsimile machine, or a multifunction machine having a plurality of functions including the copy function and the facsimile function. Of course, it may be a printer of a different type from the laser beam type, such as an inkjet printer.

The printer 102 includes a video controller 103, a panel section 104, a printer engine 105, and an external memory interface (I/F) section 312. The video controller 103 generates raster data on a page-by-page basis from print data (written e.g. in the ESC code, the page description language, and so forth) supplied from the data processing apparatus 101, and delivers (outputs) the generated raster data to the printer engine 105.

The panel section 104 is used as a user interface. The user can designate a desired operation by operating the panel section 104. Further, the panel section 104 displays the information on processing executed by the printer 102 or a warning to the user, and the display thereon disappears when in a power-saving mode.

The printer engine 105 forms latent images on respective photosensitive drums based on the raster image supplied from the video controller 103 and then transfers and fixes the latent images onto a sheet (by electrophotography) to thereby record (form) an image on the sheet.

An external memory 106 is a removable storage medium, such as a USB flash drive or an SD card. The external memory 106 exchanges data with the video controller 103.

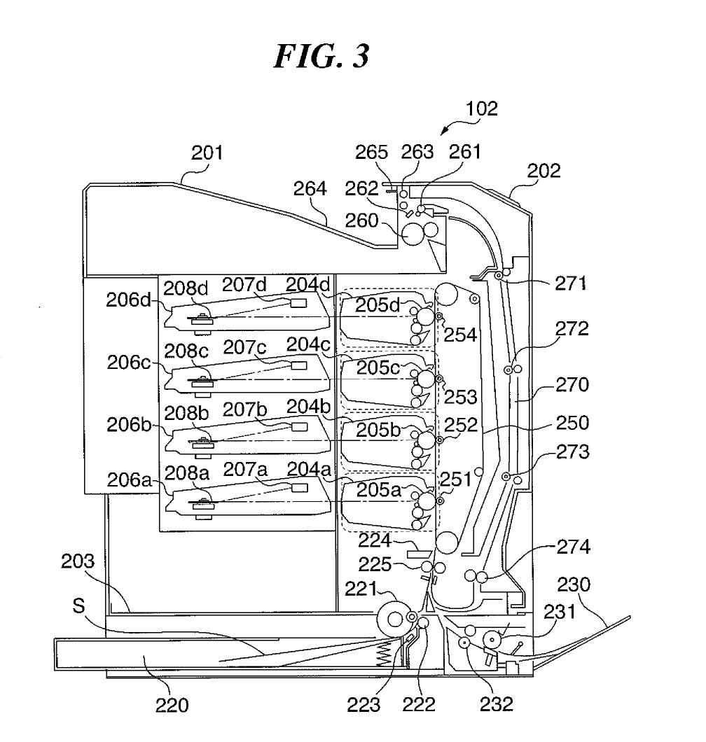

FIG. 3 is a view of the construction of the printer appearing in FIG. 1.

As shown in FIG. 3, the printer 102 has a printer housing 201, and an operation panel 202. The operation panel 202 is provided with switches for use by the user in giving various instructions, and LED indicators, an LCD display, and the like for indicating or displaying messages, printer settings, and so forth. The operation panel 202 is an embodiment of the panel section 104 in FIG. 2.

A board compartment 203 accommodates a board forming respective electronic circuit parts of the video controller 103 and the printer engine 105. A sheet cassette 220 holds sheets (recording media) S. The sheet cassette 220 has a mechanism for electrically detecting sheet sizes by a partition plate, not shown.

A cassette clutch 221 has a cam for taking out an uppermost one of the sheets S stacked in the sheet cassette 220 and conveying the sheet S to a feed roller 222 by a driving force transmitted from a driving means, not shown. This cam rotates intermittently for each sheet feeding operation, and feeds one sheet S by one rotation. A sheet detecting sensor 223 detects the amount of sheets S held in the sheet cassette 220.

The feed roller 222 conveys the sheet S until the leading end of the same reaches a registration shutter 224. The registration shutter 224 has a function of stopping sheet feed by pressing the sheet S.

A manual feed tray 230 is disposed on a side surface of the printer housing 201, and a manual feed clutch 231 is disposed at a location forward of the manual feed tray 230 in a sheet feeding direction. The manual feed clutch 231 is used to convey a sheet S until the leading end of the same reaches a manual feed roller 232, and the manual feed roller 232 is used to convey the sheet S until the leading end of the same reaches the registration shutter 224. A sheet S for printing is fed by selecting either the sheet cassette 220 or the manual feed tray 230 as a sheet feeding means.

The printer engine 105 communicates with the video controller 103 according to a predetermined communication protocol. Then, the printer engine 105 selects one of the sheet cassette 220 and the manual feed tray 230 according to an instruction from the video controller 103, and conveys a sheet S to the registration shutter 224 from the selected sheet feeding means in response to a printing start instruction.

It should be noted that the printer engine 105 includes the sheet feeding means, a mechanism for use in an electrophotographic process including a latent image forming operation, a transfer operation, and a fixing operation, a sheet discharge means, and a control means for controlling these.

Each of printing sections 204a, 204b, 204c, and 204d includes an associated one of the photosensitive drums 205a, 205b, 205c, and 205d and a toner holder, and forms a toner image on the sheet S by the electrophotographic process. On the other hand, each of laser scanner sections 206a, 206b, 206c, and 206d supplies image information to an associated printing section 204 using a laser beam.

For the printing sections 204a, 204b, 204c, and 204d, a sheet conveyor belt 250 for conveying the sheet S is stretched flat in the sheet conveying direction (vertically upward as viewed in FIG. 3) by a plurality of rotating rollers 251 to 254. The sheet S is electrostatically attracted to the sheet conveyor belt 250 by a biased attraction roller pair 225 in the vicinity of a most upstream location in the sheet conveying direction.

The four photosensitive drums 205a, 205b, 205c, and 205d are linearly arranged in facing relation to the sheet conveying surface of the sheet conveyor belt 250 to constitute an image forming means. In each of the printing sections 204a, 204b, 204c, and 204d, an electrostatic charger and a developing device are arranged around the associated photosensitive drum 205 at respective locations close to the outer peripheral surface of the same.

The laser scanner sections 206a, 206b, 206c, and 206d has laser units 207a, 207b, 207c, and 207d, respectively. The laser unit 207 drives a built-in semiconductor laser according to an image signal (/VIDEO signal) delivered from the video controller 103, to thereby emit a laser beam.

The laser beam emitted from each of the laser units 207a, 207b, 207c, and 207d is irradiated onto an associated one of the photosensitive drums 205a, 205b, 205c, and 205d by being scanned by an associated one of polygon mirrors (rotary polygon mirrors) 208a, 208b, 208c, and 208d, to form a latent image on the associated photosensitive drum.

A fixing device 260 thermally fixes on a sheet S a toner image formed on the sheet S by the printing sections 204a, 204b, 204c, and 204d. A conveying roller 261 conveys the sheet S in a sheet discharging direction. A sheet discharge sensor 262 detects the discharge state of the sheet S.

A discharge roller pair-double-sided printing conveying path-switching roller pair 263 conveys the sheet S in the sheet discharging direction, and immediately discharges the sheet S when discharge of the sheet S is designated by a sheet conveying instruction for conveying the sheet S. On the other hand, when double-sided conveyance is designated by the sheet conveying instruction, the roller pair 263 reverses the direction of its rotation immediately after the trailing end of the sheet S has passed the sheet discharge sensor 262, to thereby switch back the sheet S into a double-sided printing conveying path 270.

A discharged sheet stack amount sensor 265 detects the amount of sheets S stacked on a discharge tray 264. The sheet S conveyed into the double-sided printing conveying path 270 by the discharge roller pair-double-sided printing conveying path-switching roller pair 263 is conveyed again to the registration shutter 224 by double-sided conveying rollers 271 to 274 and awaits a conveyance instruction for conveying the sheet S to the printing sections 204a, 204b, 204c, and 204d.

It should be noted that the printer 102 can be further equipped with optional units, such as an optional cassette and an envelope feeder.

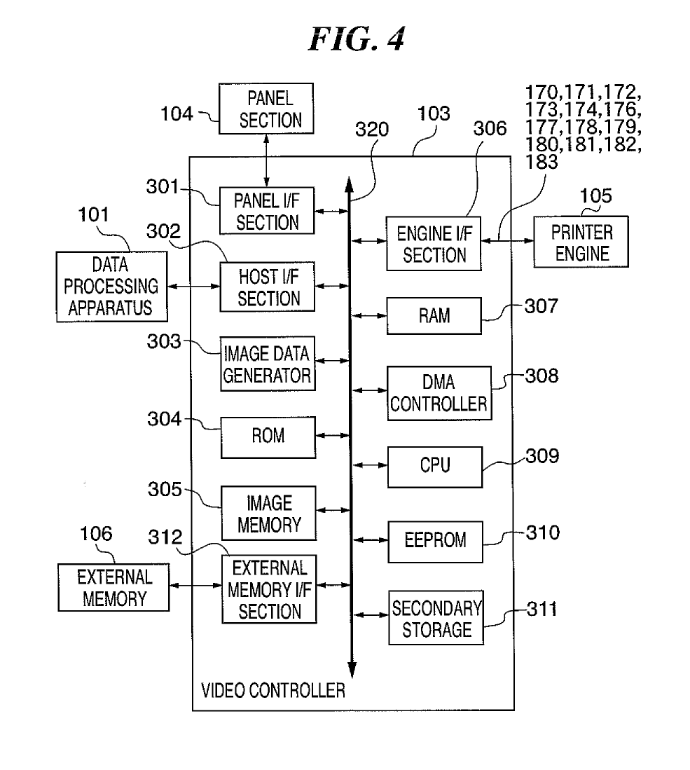

FIG. 4 is a block diagram of the video controller appearing in FIG. 2.

Referring to FIG. 4, a panel interface (I/F) section 301 performs data communication with the panel section 104. A host interface section 302 establishes bidirectional communication connection with the data processing apparatus 101 as a host computer, and an information terminal apparatus, such as a PDA or a cellular phone, via the network or a local interface section, such as a USB.

An image data generator 303 generates raster data (rasterizes print data) to be supplied to the printer engine 105, based on print data supplied from the data processing apparatus 101. An image memory 305 temporarily stores the generated raster data. An engine interface (I/F) section 306 establishes communication connection with the printer engine 105. A RAM 307 is used by a CPU 309 as a memory for temporary storage, and is configured such that the memory capacity thereof can be increased by using an optional RAM connected to an expansion port, not shown.

Further, the RAM 307 is used as a rendered image storage for storing rendered images, a work memory for temporarily used by a control program stored in a ROM 304, and so forth.

A DMA controller 308 transfers the raster data stored in the image memory 305 to the engine interface section 306 according to an instruction from the CPU 309.

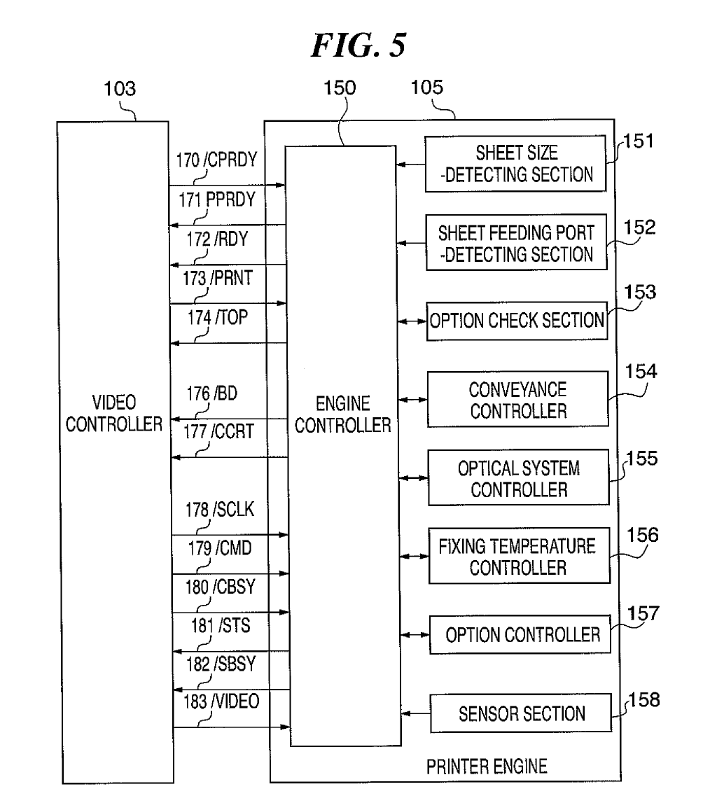

The CPU 309 is capable of confirming settings and instructions input by the user from the panel section 104, via the panel interface section 301. Further, the CPU 309 controls signals 170, 173, 178, 179, 180, and 183 shown in FIG. 5, via the engine interface section 306. The CPU 309 is also capable of recognizing the statuses of respective signals 171, 172, 174, 176, 177, 181, and 182, i.e. the state of the printer engine 105.

The CPU 309 also controls devices connected to a CPU bus 320, based on a control program code stored in the ROM 304.

Further, the CPU 309 functions as an external memory confirmation means for searching user information and stored data information stored in the external memory 106, when triggered by attachment of the external memory 106.

The CPU 309 also functions as a state detection means for detecting the state of the printer 102, including information on capabilities of the same, and a priority determination means for determining priorities of functions associated with the external memory 106 to determine a function to be executed.

When execution of job saving is determined to be executed by the priority determination means, the CPU 309 functions as a job saving means for copying a job in the printer 102 into the external memory 106 and then deleting the job from the printer 102.

Further, the CPU 309 functions as a saved job printing means. When execution of job saving is determined by the priority determination means, the saved job printing means causes the printer 102 in which the external memory 106 is attached to print the job saved therein, and then deletes the saved job from the external memory 106 after completion of the printing.

A nonvolatile memory (EEPRON) 310 stores control information, such as a density correction table, for example. A secondary storage 311 implemented e.g. by a hard disk stores print data, control information, and so forth. Print data received from the data processing apparatus 101 and kept on standby for execution of print processing by the printer engine 105 is stored in the secondary storage 311. The external memory interface (I/F) section 312 provides interface with the external memory 106.

The CPU bus 320 includes an address bus, a data bus, and a control bus. The above-mentioned devices can access all other devices connected to the CPU bus 320.

FIG. 5 is a diagram showing blocks constituting the printer engine appearing in FIG. 2 and the signal lines between the video controller and the printer engine.

The printer engine 105 is comprised of an engine controller 150 and units 151 to 158 described hereinbelow. The engine controller 150 controls each of the units 151 to 158 within the printer engine 105 based on an associated control signal delivered from the video controller 103.

A sheet size-detecting section 151 detects the size of sheets placed in each of the sheet cassette 220 and the other optional cassettes (not shown), and notifies the engine controller 150 of the detected size. A sheet feeding port-detecting section 152 detects the sheet feeding port of each of the sheet cassette 220, the manual feed tray 230, the other optional cassettes (not shown), and the envelope feeder (not shown), and notifies the engine controller 150 of the detected sheet feeding port.

An option check section 153 checks the connection state of an optional unit, such as the optional cassette or the envelope feeder. A conveyance controller 154 controls conveyance of a sheet. An optical system controller 155 controls drive motors for driving the polygon mirrors 208a, 208b, 208c, and 208d, and an optical system including the laser units 207a, 207b, 207c, and 207d.

A fixing temperature controller 156 performs not only temperature control of the fixing device 260, but also abnormality detection in the fixing device 260. An option controller 157 controls an optional unit, such as the optional cassette or the envelope feeder. A sensor section 158 collectively represents sensors for detecting the presence/absence of a sheet in each of conveying paths including the registration shutter 224, the double-sided printing conveying path 270, and an inverting path, in which is included the sheet discharge sensor 262, and sensors for detecting changes in environment (conditions), the ambient temperature, the number of pages for printing, the remaining amount of toner, and so forth.

Next, a brief description will be given of each of the signals constituting a video interface for connection between the video controller 103 and the engine controller 150.

The /CPRDY signal 170 indicates that the video controller 103 is communicable with the engine controller 150. The /PPRDY signal 171 indicates that the engine controller 150 is communicable with the video controller 103.

The /RDY signal 172 indicates that the engine controller 150 is ready for printing. The /PRNT signal 173 is output by the video controller 103 for making a print request to the engine controller 150.

The /TOP signal 174 is a vertical synchronizing signal output from the engine controller 150 to the video controller 103. The /BD signal 176 is a horizontal synchronizing signal output from the engine controller 150 to the video controller 103.

The /SCLK signal 178 is a synchronizing clock signal for use in serial communication. The /CMD signal 179 is a command signal output from the video controller 103 to send a command to the engine controller 150.

The /CBSY signal 180 is a strobe signal for transmitting a command. The /STS signal 181 is output from the engine controller 150 to send a response (including information on a state inside the engine controller 150) to the command transmitted from the video controller 103.

The /SBSY signal 182 is a strobe signal for sending a response including status information. The /VIDEO signal 183 is output as raster data. The /CCRT signal 177 is asserted “TRUE” when a status change that does not directly concern the /RDY signal 172, i.e. a status change that does not directly concern enabling/disabling of printing occurs. The case where such a status change occurs is e.g. a case where the ambient temperature, the number of pages for printing, or the remaining amount of toner exceeds an associated reference value.

Print processing executed by the above described printing apparatus according to the present embodiment will be described below.

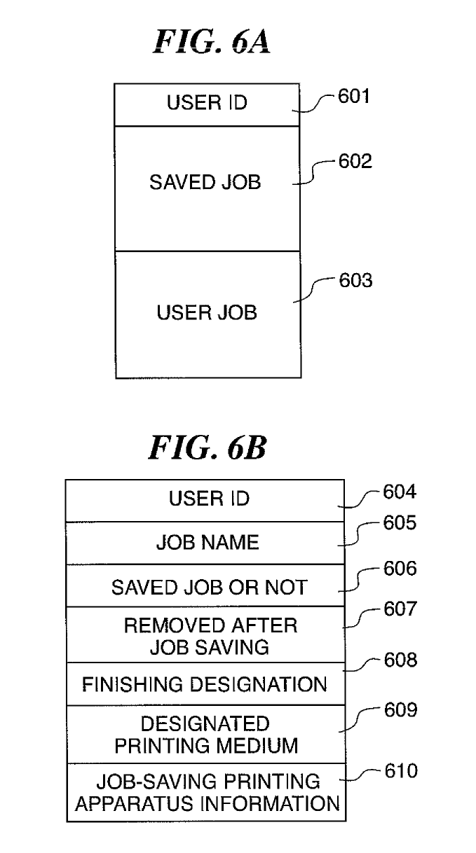

FIGS. 6A and 6B are diagrams useful in explaining the structure of information to be stored in the external memory appearing in FIG. 2.

FIG. 6A represents jobs stored in the external memory. A user ID 601 indicates the owner of the external memory 106, and is the same as a user ID attached to the print job.

Registration of the user ID may be performed by attaching the external memory 106 to the data processing apparatus 101 and using an application stored in the data processing apparatus 101. Alternatively, the external memory 106 may be attached to the printer 102. In this case, the user ID may be directly input via the UI (panel) section 104 of the printer 102, or user ID information stored in the printer 102 may be displayed on the UI of the printer 102, and then an ID to be registered may be selected from displayed user IDs and be copied into the external memory 106.

A saved job 602 represents information on a job saved from the secondary storage 311 of the printer 102. The saved job 602 includes print data saved from the secondary storage 311 and management information shown in FIG. 6B. A user job 603 represents information on jobs other than the saved job, and this information is managed independently of the saved job 602.

Next, the management information shown in FIG. 6B will be described below.

A user ID 604 is used as information for identifying the owner of the saved job. A job name 605 is used by the user as information for identifying the job. Information 606 indicative of whether or not the job is a save job is used as information for identifying the job saved from the printer 102.

“Removed after job saving” information 607 is used to determine whether saving of a job was performed when the external memory 106 was attached to the printer 102 this time, or when it was attached on another occasion. Information 608 is on settings of the saved job, and is used to determine whether or not finishing functions, such as a stapling function and a job offset function, can be performed in printing of the saved job 602. It should be noted that other printing-related settings including a setting for double-sided/single-sided printing, a setting for color/monochrome printing, and a layout setting, such as Ninl, can also be configured in the finishing designation 608.

Information 609 is on a designated print medium, and is used to determine whether or not the designated job can be printed without error. In the case of executing proxy printing, an alternative printer 102 is sometimes incapable of performing printing as specified, due to different capabilities. In such a case, the information 608 and 609 can be used to notify the user of the fact.

Job-saving printing apparatus information 610 is on a printing apparatus from which the job was saved. The information 610 is used as information for determining whether to execute the saved job or whether to display a warning message and for notifying the original printer that the saved job was printed by another printer 102.

FIG. 7 is a flowchart of an external memory attachment-responsive process executed by the video controller in FIG. 4.

The present process is executed by the CPU 309 appearing in FIG. 4.

Referring to FIG. 7, when the user inserts a USB flash drive (external memory 106) into the printer 102, first, the user ID and data information in the USB flash drive are checked (step S701). More specifically, the CPU 309 checks the presence/absence of each of the user ID 601, the saved job 602, and the user job 603, described with reference to FIG. 6, so as to be ready for determining which of USB flash drive functions can be performed.

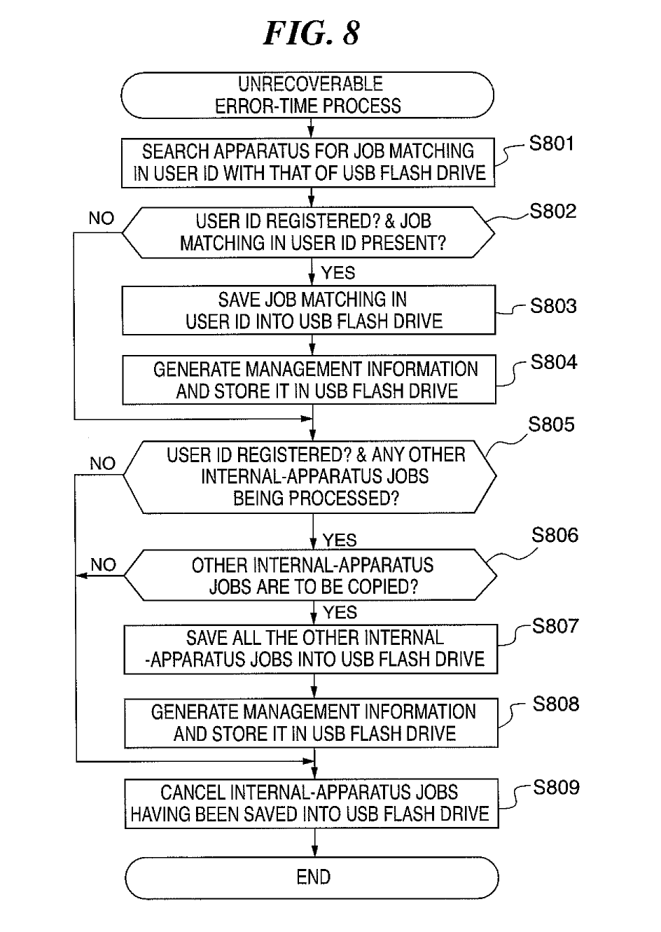

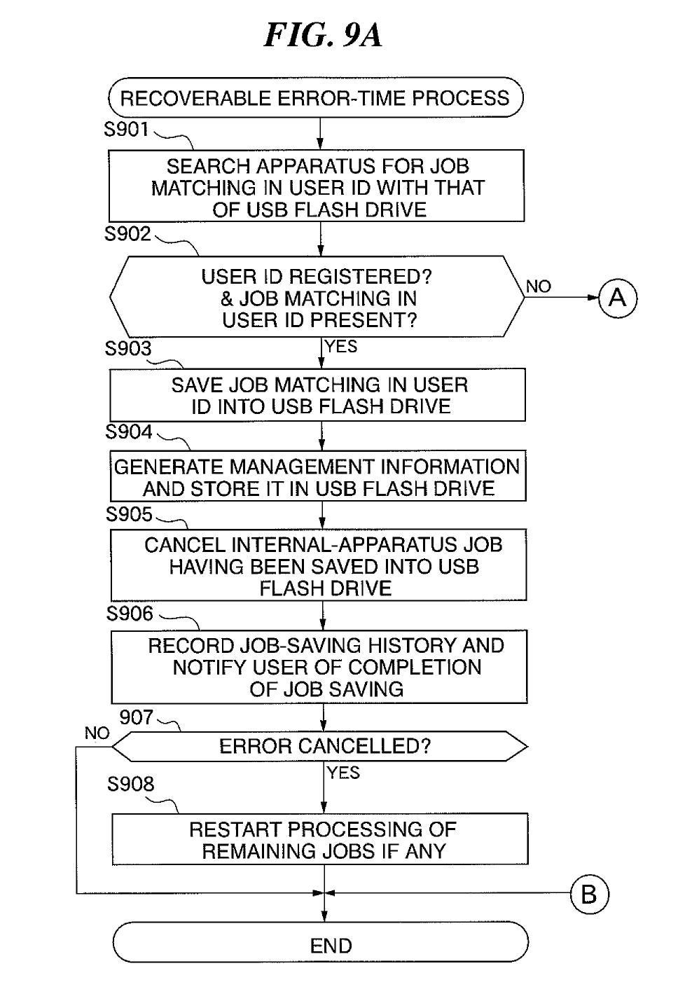

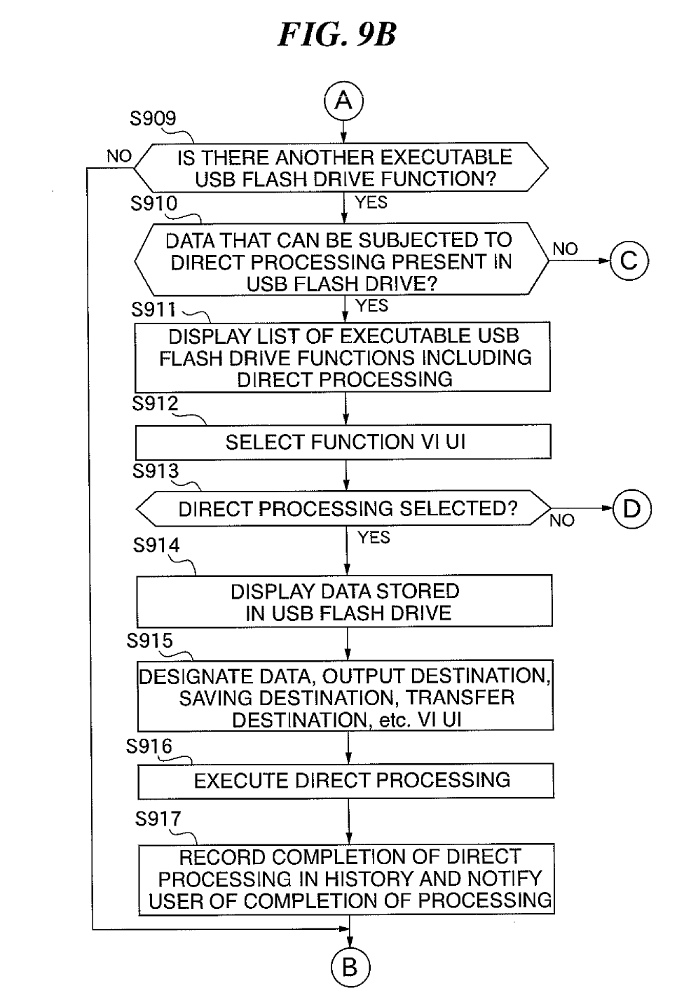

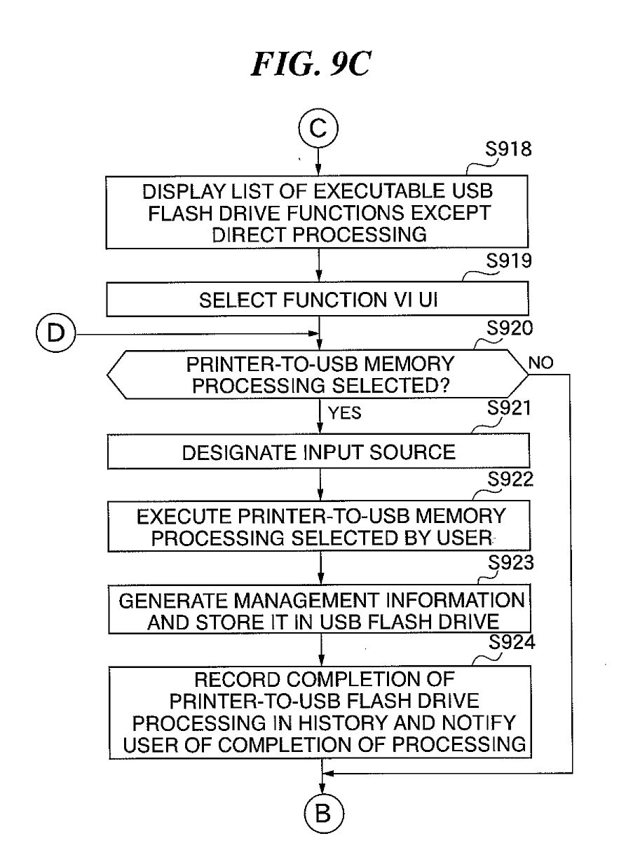

The term “USB flash drive function” refers to a function that can be realized by inserting the USB flash drive into the printer 102. For example, one of the USB flash drive functions is the direct printing function for causing the printer 102 to print out print data and image data stored in the USB flash drive in response to insertion of the USB flash drive into the printer 102. Further, as described in detail hereinafter with reference to flowcharts in FIGS. 8 and 9, a function of saving a job stored in the secondary storage 311 of the printer 102 into the USB flash drive is also included in the USB flash drive functions. Furthermore, when the printer 102 according to the present embodiment is provided with a function of scanning an original, the Scan-to-USB function for storing scanned image data into the USB flash drive is also one of the USB flash drive functions. Besides, functions realized by cooperation between the USB flash drive and the printer 102 are all included in the USB flash drive functions.

In a step S702, the capabilities of the printer 102 are detected by referring to a capability table associated with the printer 102 so as to be ready for determining whether or not the jobs checked in the step S701 can be processed. It should be noted that the capability table is stored in the secondary storage 311, the EEPROM 310, or the ROM 304, and information items of the functions, equipment, specifications, and capabilities of the printer 102 are stored in the capability table. By referring to the capability table, it is possible to determine whether or not printing can be performed according to print settings (designated settings of finishing, single-sided/double-sided printing, and a print sheet) designated in the job.

Next, the state of the printer 102 is checked so as to determine whether or not an error has occurred (step S703). Further, if an error has occurred, it is determined whether the error is recoverable or unrecoverable (step S704).

A recoverable error means an error state, such as absence of sheets, running-out of a consumable article like toner, paper jam, or a fully-stacked state of a discharge tray, which can be recovered by some user operation, i.e. an error state from which the printer 102 can be relatively easily recovered to restore a normal state.

On the other hand, an error which cannot be cancelled or fixed by anyone but an administrator or a service person, i.e. an error which cannot be recovered by an ordinary user is defined as an unrecoverable error. For example, an error that the printer 102 has an unsupported component mounted therein, an error that a staple jammed in a stapler hinders proper operation of a motor, and an error that writing in an HDD is disabled are unrecoverable errors. Further, an error in which the same paper jam repeatedly occurs each time printing operation is restarted after cancelling the error may be determined as an unrecoverable error (error difficult to recover from).

If it is determined in the steps S703 and S704 that an unrecoverable error has occurred, the process proceeds to a step S705, whereas if it is determined that a recoverable error has occurred, the process proceeds to a step S706. On the other hand, if no error has occurred, i.e. if the printer 102 is in its normal state, the process proceeds to a step S707. Processes executed in the respective steps S705, S706, and S707 will be described in detail with reference to FIGS. 8, 9, and 10, respectively.

When the process in the step S705, S706, or S707 is terminated, it is determined whether or not there is another executable USB flash drive function (than the function performed in the step S705, S706, or S707) (step S708). If there is, the process returns to the step S703, whereas if not, a message is displayed on the panel section 104 to prompt the user to remove the USB flash drive (step 8709). Then, when the USB flash drive is removed (step S710), the present process is terminated. It should be noted that processing for removing the USB flash drive may be carried out in the step S710.

FIG. 8 is a flowchart of an unrecoverable error-time process executed in the step S705 in FIG. 7.

Referring to FIG. 8, first in a step S801, the secondary storage 311 of the printer 102 is searched for a job with a user ID that matches a user ID in the USB flash drive.

If it is determined in a step S802 that there is a user ID registered in the USB flash drive and a job with a user ID matching the user ID registered in the USB flash drive exists in the secondary storage 311, the job is saved into the USB flash drive (step S803). Further, the management information shown in FIG. 6B is generated and stored in the USB flash drive in association with the saved job (step S804).

Then, if it is determined in a step S805 that there is no other job being currently processed than the job associated with the above user (NO to the step S805), the job saved in the USB flash drive is canceled (step S809), followed by terminating the present process. If the user ID has not been registered (NO to the step S802, and NO to the step S805), the present process is terminated without executing the job-saving processing.

If the user ID has been registered and if a job associated with another user remains in the secondary storage 311 (YES to the step S805), an inquiry as to whether to save the job is notified to the user of the USB flash drive. If the user designates saving of the remaining job, the remaining internal-apparatus job (job in the secondary storage 311) is also saved into the USB flash drive in the same manner as in the step S803 (step S807).

Then, management information is generated and stored in the USB flash drive in association with the saved job (step S808). Further, the job saved in the USB flash drive is canceled in the step S809, followed by terminating the present process.

The reason why the job other than the job associated with the USB flash drive user is also saved in the USB flash drive is as below. For example, the administrator responsible for repairing the printer 102 needs to turn off the power thereof even if unfinished internal-apparatus jobs remain in the secondary storage 311, and hence it is required to save all unfinished jobs from the printer 102 before the power is turned off, so as to enable them to subjected to proxy printing, and thereby prevent jobs associated with other people from being deleted without permission. However, there is also a use case where a user does not want proxy printing to be executed on his job by a person other than the user without his permission. Therefore, the steps S805 to S808 may not be executed. Alternatively, the program may be configured such that only when a USB flash drive with the user ID of a specific user, such as an administrator or an equally or more empowered user of the printer or the network, is attached, the steps S805 to S808 can be executed.

According to the unrecoverable error-time process in FIG. 8, when an unrecoverable error has occurred in a printer, a job with a user ID matching a user ID registered in a USB flash drive in advance can be saved into the USB flash drive, and by inserting this USB flash drive into another printer normally operating, it is possible to print out the saved job using the printer.

On the other hand, if a user ID has not been registered in the USB flash drive, the job is not saved, whereby only when a USB prepared for job saving is used, automatic job saving is performed.

Therefore, it is possible to prevent an erroneous operation from being performed by a user using a USB flash drive for another purpose than job saving. Further, so long as a user ID is managed, it is possible to track jobs associated with the user ID. This makes it possible to provide a system safe in terms of security.

FIGS. 9A to 9C are a flowchart of the recoverable error-time process executed in the step S706 in FIG. 7.

Referring to FIGS. 9A to 9C, first in a step S901, the secondary storage 311 is searched for an internal-apparatus job with a user ID that matches the user ID registered in the USB flash drive.

If it is determined in a step S902 that there is a user ID registered in the USB flash drive and there exists in the secondary storage 311 an internal-apparatus job with a user ID matching the registered user ID exists, the job is saved into the USB flash drive (step S903). Further, the management information shown in FIG. 6B is generated and stored into the USB flash drive in association with the saved job (step S904).

Then, the internal-apparatus job saved into the USB flash drive is canceled (step S905), and the execution of the job saving is recorded in a history file, whereafter processing for notifying the user of completion of the job saving is executed (step S906).

If the error is cancelled by the above described operation (step S907), processing of remaining internal-apparatus jobs is restarted (step S908), followed by terminating the present process. If the user ID has not been registered in the USB flash drive, processing for job saving is not carried out, similarly to the process described with reference to FIG. 8.

If it is determined in the step S902 that there is no internal-apparatus job matching in user ID, the process proceeds to a step S909, wherein it is determined whether or not there is another executable USB flash drive function. If there is an executable USB flash drive function, processing is started using the function. If a job matching in user ID is not present in the apparatus and if there is no other executable USB flash drive function, the present process is terminated.

If there is an executable USE flash drive function, it is determined, based on the data information in the USB flash drive checked in advance in the step S701, whether or not data that can be subjected to direct processing is present (step S910). The term “direct processing” refers to processing executed using the direct printing function, for example. Data that can be subjected to direct processing is stored in the area of the user job 603 in the USB flash drive. If data is stored in the area of the user job 603 and if the data can be printed by the printer 102, the data is determined to be data that can be subjected to direct processing.

If data that can be subjected to direct processing is present, a list of user-selectable USB flash drive functions including the direct processing function is displayed on the panel section 104 (step S911). If it is determined in the step S910 that data that can be subjected to direct processing is not present, the USB flash drive functions except the direct processing function are displayed (step S918), for the user to select one therefrom (step S919).

As for the function display, when a plurality of lines can be displayed, the functions may be displayed on a single screen, whereas when it is impossible to display all the functions at once, functions may be displayed by toggle display or user operation, so as to enable the user to select one.

In a step S912 following the step S911, the user selects a predetermined function from the displayed functions. When the function selected by the user is the direct processing function (YES to a step S913), jobs in the USB flash drive, which can be subjected to direct processing, are displayed (step S914).

When the direct processing function is selected, the user carries out the following operations via the UI (panel section 104) (step S915). More specifically, there are executed an operation for selecting data to be subjected to direct processing, and an operation for selecting whether to print out the selected data by the printer 102 currently in operation or by another printer 102 after transferring the data thereto, or an operation for designating a storage destination for storing the data, e.g. the secondary storage 311, instead of printing out the same are executed.

Then, direct processing is executed (step S916). When the direct processing is completed, execution of the direct processing is recorded in the history file, and the completion of the direct processing is notified to the user via the UI display or the like (step S917), followed by terminating the present process.

If the function selected by the user is not the direct processing function (NO to the step S913), but a function of transferring data from the printer 102 to the USB flash drive (YES to a step S920), the following processing is executed:

For example, an input source, such as the scanner or the EEPROM 310 storing user environment information is designated via the UI (step S921), and the transfer function designated by the user is performed (step S922). Then, management information is generated and stored into the USB flash drive in association with the transferred data (step S923). Further, the completion of the saving processing is recorded in the history file, and is notified to the user (step S924), followed by terminating the present process. The processing executed in the steps S921 to S924 is similar to that executed in the steps S903 to S906, but the former is different from the latter in that the user can select data to be transferred to the USB flash drive, as desired.

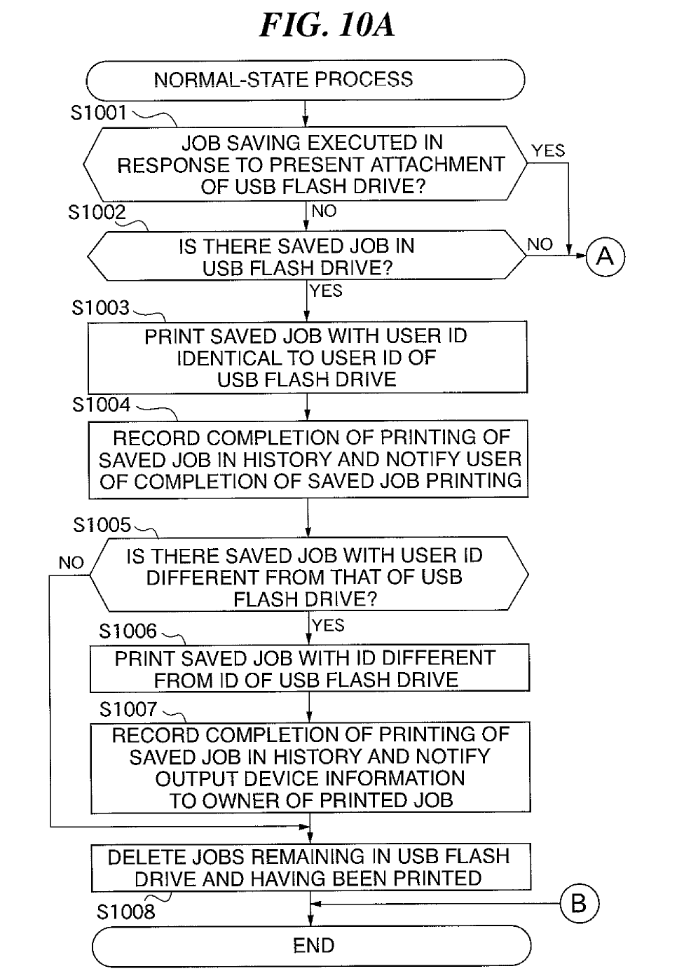

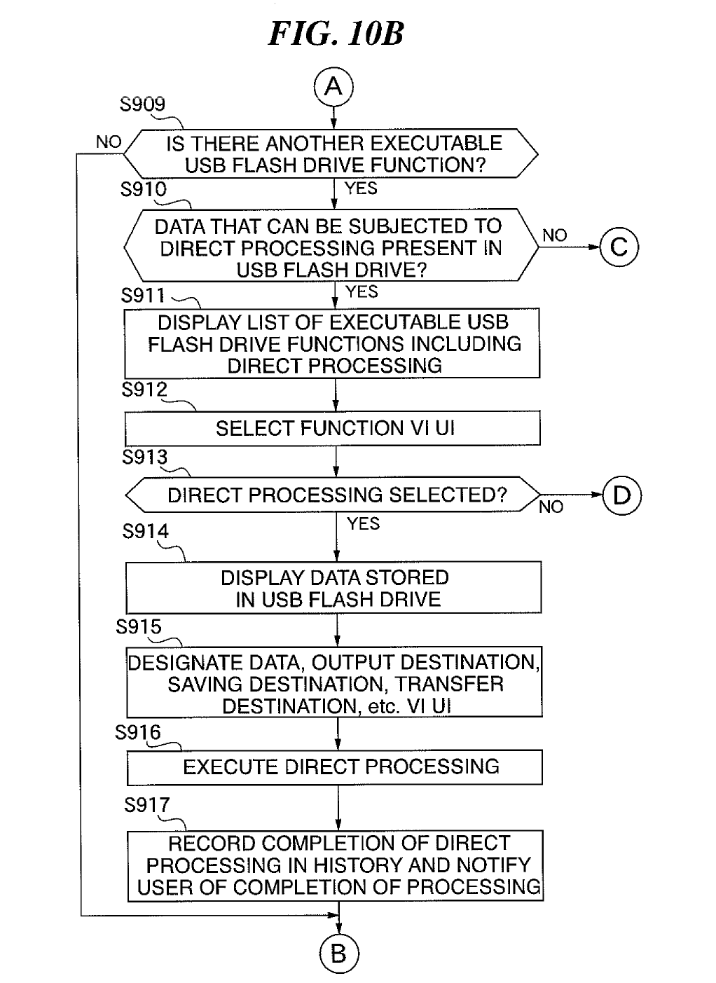

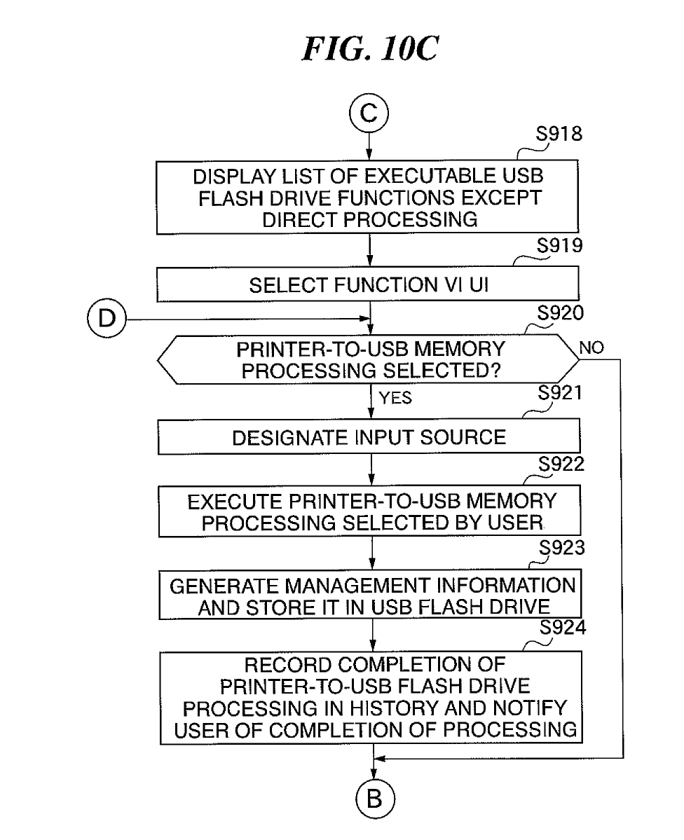

FIGS. 10A to 10C are a flowchart of the normal-state process executed in the step S707 in FIG. 7.

The term “normal state” refers to a state where no error, particularly no such error as described above, has occurred, i.e. a state where the printer 102 is processing a job or a state where the printer 102 is on standby for processing a job.

Referring to FIGS. 10A to 10C, first in a step S1001, it is determined, based on the data information in the USB flash drive checked in advance in the step S701, whether or not saving of a job was performed when the USB flash drive was attached this time. In this case, if the “removed after job saving” information 607 of the management information described hereinbefore with reference to FIG. 6B indicates that a flag of “removed after job saving” is on, it is determined that the answer to the question of the step S1001 is negative (NO), whereas if the flag is off, it is determined that the answer is affirmative (YES). That is, a job having just been saved is inhibited from being printed.

If a job saved before the present attachment of the USB flash drive is present in the USB flash drive (YES to a step S1002), the process proceeds to a step S1003 irrespective of whether the job was saved from another printer 102 or from the present printer 102. The CPU 309 determines whether or not the job was saved from another printer 102, by comparison between the job-saving printing apparatus information 610 in the management information shown in FIG. 6B and its own apparatus. In the step S1003, the job saved in the USB flash drive is printed. If there are a plurality of jobs saved in the USB flash drive, a saved job having the same user ID as that of the owner of the USB flash drive (i.e. the user ID 601 in FIG. 6A) attached thereto is preferentially printed.

Then, the CPU 309 records the completion of printing of the saved job in the history file, and then notifies the user of the completion of printing of the saved job e.g. by UI display (step S1004). If a saved job having a different user ID from that of the owner of the USB flash drive exists (YES to a step S1005), the job is also printed (step S1006).

Then, the completion of printing of the saved job is recorded in the history file, and information for identifying the location and name of the printer 102 that printed out the saved job is sent to the owner of the job based on the related information in the management information (step S1007). Thereafter, all the saved jobs in the USB flash drive which have been printed in the saved job printing are deleted from the USB flash drive (step S1008), followed by terminating the present process.

If it is determined in the steps S1001 and S1002 that there is no saved job in the USB flash drive or that a saved job present in the USB flash drive was saved by the present attachment of the USB flash drive, printing of the saved job is not executed, but another USB flash drive function is performed. This processing is the same as that executed in the steps S909 et sec. in FIGS. 9B and 9C. Therefore, steps identical to those in FIGS. 9B and 9C are denoted by the same step numbers, and description thereof is omitted.

As described above, the priorities of respective processing operations are changed depending on information stored in the USB flash drive and the state of the printer 102, whereby the processing operations are performed in order of priority optimized for the respective conditions of the USB flash drive and the printer 102.

The following are examples of the case where the printer 102 has only one saving function.

(1) When the printer 102 is in its normal state and when data that can be subjected to direct processing is present in the external memory 106, it is determined that the job in the external memory 106 is very likely to be printed, and processing operations are performed in order of priority of “automatic printing of a saved job”>“direct processing”>“job saving by user selection”. Thus, the priority of the job saving operation is lowered.

(2) When the printer 102 is in its normal state and when data that can be subjected to direct processing is not present in the external memory 106, it is determined that a job saved in the external memory 106 is very likely to be printed, and processing operations are performed in order of priority of “automatic printing of a saved job”>“job saving by user selection”. In this case, direct processing is disabled, and therefore it is excluded from the menu of choices.

(3) When a recoverable error has occurred and when data that can be subjected to direct processing is present in the external memory 106, it is determined that even though there is data that can be subjected to direct processing, there is little possibility that the data is going to be printed on purpose by the printer 102 in which the error has occurred. As a consequence, processing operations are performed in order of priority of “automatic execution of job saving”>“direct processing”. Thus, the job saving operation is prioritized, and hence even if there is a saved job, printing thereof is not executed. Further, since the data that can be subjected to direct processing is more likely not to be printed by the printer 102 having the external memory 106 attached thereto but to be printed by another printer 102 after sending the data thereto, printing is executed on a second priority basis.

(4) When an unrecoverable error has occurred and when data that can be subjected to direct processing is present in the external memory 106, it is determined that even though there is data that can be subjected to direct processing, there is little possibility that the data is going to be subjected to processing, such as printing or transfer, on purpose by the printer 102 which needs repairing or component replacement. Therefore, only “automatic execution of job saving” is performed.

(5) When an error has occurred and when data that can be subjected to direct processing is not present in the external memory 106, it is determined that since there is no data that can be subjected to direct processing, the possibility of job saving is high. Therefore, only “automatic execution of job saving” is performed.

In the present embodiment, when a recoverable error has occurred, only a job of the owner of an external memory is automatically saved. On the other hand, when an unrecoverable error has occurred, only a job of the owner of the external memory is automatically saved, and whether or not to save a job of a person other than the owner of the external memory, as well, is determined by user selection. Thus, whether or not to save another person's job can be selectively determined by the user.

In addition, the printing apparatus may be configured such that upon occurrence of an unrecoverable error, a job of the owner of the external memory is automatically saved without user operation, and upon occurrence of a recoverable error, an inquiry is made to the user first, and then a job of the owner of the external memory is saved.

This makes it possible to increase the range of user operation upon occurrence of a recoverable error, and to simplify the operation upon occurrence of an unrecoverable error.

In the present embodiment, irrespective of the kind of a job, upon occurrence of a recoverable error, only a job of the owner of the external memory is saved, and upon occurrence of an unrecoverable error, whether or not to save a job of a person other than the owner of the external memory, as well, is determined by user selection.

In addition, the printing apparatus may be configured such that upon occurrence of a recoverable error, only the job currently being processed is saved, and upon occurrence of an unrecoverable error, jobs of the owner of the external memory, including not only the job currently being processed but also inactive jobs, such as stored jobs and secure jobs, can be selectively saved.

This makes it possible to cause the printing apparatus to operate in such a manner that the user can select whether or not to save only the job currently being processed.

Although in the present embodiment, job saving is performed upon occurrence of an error, job saving may be also performed in a case where a job was output, but could not be printed as specified. In this case, the job is stored in a printer over a predetermined time period and is then saved into an external memory. The case where a job could not be printed as specified includes a case where the stapling function of a finisher has been degraded, and hence a stapling-specified job is printed without being stapled, or a case where memory shortage causes degradation of image quality.

Thus, not only when a job cannot be output, but also when a lob cannot be printed as specified, it is possible to re-output the job using another printer 102, which makes it possible for a user to obtain a desired output.

Although in the present embodiment, the printing apparatus is implemented by the printer 102, by way of example, there is also a multifunction machine with a scanner, which is equipped with a function of storing scan data into an external memory, such as a USB flash drive. Further, in addition to the function related to the scanner, the multifunction machine is provided with a plurality of saving functions operable by a user for saving information into an external memory. Therefore, the multifunction machine may be configured to be operable such that processing operations can be performed in the following order of priority to prevent erroneous operation.

(1) When the multifunction machine is in its normal state and when data that can be subjected to direct processing is present in the external memory 106, it is determined that a job in the external memory 106 is very likely to be printed, and processing operations are performed in order of priority of “automatic printing of a saved job”>“direct processing”>“job saving by user selection”=“Scan to USB”. Thus, the priority of the job saving operation is lowered.

(2) When the multifunction machine is in its normal state and when data that can be subjected to direct processing is not present in the external memory 106, it is determined that a job saved in the external memory 106 is very likely to be printed, and processing operations are performed in order of priority of “automatic printing of a saved job”>“job saving by user selection”=“Scan to USB”. In this case, direct processing is disabled, and therefore the operation is excluded from the menu of choices.

(3) When a recoverable error has occurred and when data that can be subjected to direct processing is present in the external memory 106, it is determined that even though there is data that can be subjected to direct processing, there is little possibility that the data is going to be printed on purpose by the printer 102 in which the error has occurred is low. As a consequence, processing operations are performed in order of priority of “automatic execution of job saving”>“direct processing”>“Scan to USB”. Thus, job saving operation is prioritized, and hence even if there is a saved job, printing thereof is not executed. Further, since the data that can be subjected to direct processing is more likely not to be printed by the printer 102 having the external memory 106 attached thereto but to be printed by another printer 102 after sending the data thereto, printing is executed on a second priority basis.

(4) When an unrecoverable error has occurred and when data that can be subjected to direct processing is present in the external memory 106, it is determined that even though there is data that can be subjected to direct processing, there is little possibility that the data is going to be subjected to processing, such as printing or transfer, on purpose by the printing apparatus which needs repairing or component replacement is low. Therefore, operations are performed in order of priority of “automatic execution of job saving”>“Scan to USB” so as to prioritize job saving for saving the job from the printing apparatus.

(5) When an error has occurred and when data that can be subjected to direct processing is not present in the external memory 106, it is determined that since there is no data that can be subjected to direct processing, the possibility of job saving is high. Therefore, operations are performed in order of priority of “selective execution of job saving”=“Scan to USB”. Thus, job saving for saving the job from the printing apparatus is prioritized, and automatic execution of job saving is disabled so as to allow the user to select a function to be executed. Other saving functions can be added following the same rule as the rule used for adding the “Scan to USB” function.

Thus, also in the multifunction machine having a plurality of saving functions including the scanner-related USB flash drive function, it is possible to realize the functions by a simple operation while preventing occurrence of an erroneous operation.

In the present embodiment, registration of a user ID in a USB flash drive is performed by manual entry by the user or through selection of user information provided in advance in the printing apparatus. However, the registration method may be configured such that the user can select and register his/her own user ID from user ID information taken out from a printing history recorded in a printer 102.

This facilitates registration of the user ID in the USB flash drive from the printer 102 that has ever been used by the user.

It is to be understood that the present invention may also be accomplished by supplying a system or an apparatus with a storage medium in which a program code of software, which realizes the functions of the above described embodiment is stored, and causing a computer (or CPU or MPU) of the system or apparatus to read out and execute the program code stored in the storage medium.

In this case, the program code itself read from the storage medium realizes the functions of the above described embodiment, and therefore the program code and the storage medium in which the program code is stored constitute the present invention.

Examples of the storage medium for supplying the program code include a floppy (registered trademark) disk, a hard disk, a magnetic-optical disk, an optical disk, such as a CD-ROM, a CD-R, a CD-RW, a DVD-ROM, a DVD-RAM, a DVD-RW, or a DVD+RW, a magnetic tape, a nonvolatile memory card, and a ROM. Alternatively, the program may be downloaded via a network.

Further, it is to be understood that the functions of the above described embodiment may be accomplished not only by executing the program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to an exemplary embodiment, it is to be understood that the invention is not limited to the disclosed exemplary embodiment. The scope of the following claims is to be accorded the broadest interpretation so as to encompass all modifications, equivalent structures and functions.

This application claims priority from Japanese Patent Application No. 2007-156436 filed Jun. 13, 2007, which is hereby incorporated by reference herein in its entirety.

What is claimed is:

1. A printing apparatus to which an external memory is removably attachable, comprising:
a printing unit configured to print out print data stored in a storage unit;
a transfer unit configured to be operable when said printing unit cannot print out the print data stored in the storage unit, to transfer print data stored in the storage unit and yet to be subjected to print processing into the external memory in response to attachment of the external memory to the printing apparatus; and
an execution unit configured to be operable when said printing unit can print out the print data stored in the storage unit, to execute a job using the external memory in response to attachment of the external memory to the printing apparatus.

2. A printing apparatus as claimed in claim 1, wherein the print data stored in the storage unit contains a user ID for identifying a user who designated execution of printing based on the print data, and
wherein said transfer unit transfers print data containing a user ID identical to a user ID stored in the external memory attached to the printing apparatus into the external memory.

3. A printing apparatus as claimed in claim 2, wherein when print data containing the user ID identical to the user ID stored in the external memory attached to the printing apparatus is not stored in said storage unit, said transfer unit does not transfer the print data stored in the storage unit into the external memory, and said execution unit executes a job which can be executed using the external memory.

4. A printing apparatus as claimed in claim 1, wherein when the external memory is attached to the printing apparatus in a state where said printing unit can print out the print data stored in the storage unit, said execution unit executes a job which can be executed using the external memory.

5. A printing apparatus as claimed in claim 1, wherein when the external memory attached to the printing apparatus in a state where the printing apparatus can perform a printout operation stores a print job transferred by a transfer unit included in another printing apparatus, said printing unit performs the printout operation based on the print data transferred from the other printing apparatus and stored in the external memory.

6. A printing apparatus to which an external memory is removably attachable, comprising:
a detection unit configured to detect a state of the printing apparatus;
a check unit configured to check contents of data stored in the external memory attached to the printing apparatus;
a determination unit configured to determine a processing operation to be carried out, based on the state of the printing apparatus detected by said detection unit and the contents of the data stored in the external memory and checked by said check unit, from a plurality of processing operations that can be executed by the printing apparatus using the external memory; and
an execution unit configured to carry out the processing operation determined by said determination unit.

7. A printing apparatus as claimed in claim 6, wherein when the printing apparatus is in an error state, said determination unit determines a processing operation for causing the external memory to store print data stored in the storage unit and yet to be subjected to print processing, as the processing operation to be carried out.

8. A printing apparatus as claimed in claim 7, wherein a processing operation determined by said determination unit as the processing operation to be carried out differs depending on whether the printing apparatus is in a recoverable error state or in an unrecoverable error state from which recovery is difficult.

9. A printing apparatus as claimed in claim 8, wherein the recoverable error state of the printing apparatus includes any of a state in which a consumable article in the printing apparatus has run out, a paper jam, and a fully-stacked state of a discharge tray.

10. A printing apparatus as claimed in claim 8, wherein the unrecoverable error state of the printing apparatus includes any of a state where a component is not properly mounted in the printing apparatus, a state where data cannot be normally read/written from/in a hard disk, a state where a staple is jammed, and a state where the same error occurs repeatedly.

11. A printing apparatus as claimed in claim 6, wherein when the printing apparatus is in a normal state, and when the external memory stores data to be printed, said determination unit determines a processing operation for causing a printout operation to be performed based on the data stored in the external memory, as the processing operation to be carried out.

12. A control method for a printing apparatus to which an external memory is removably attachable, comprising:
a printing step of printing out print data stored in a storage unit;
a transfer step of transferring, when the print data stored in the storage unit cannot be printed out in said printing step, print data stored in the storage unit and yet to be subjected to print processing into the external memory in response to attachment of the external memory to the printing apparatus; and
an execution step of executing, when the print data stored in the storage unit can be printed out in said printing step, a job using the external memory in response to attachment of the external memory to the printing apparatus.

13. A control method for a printing apparatus to which an external memory is removably attachable, comprising:
a detection step of detecting a state of the printing apparatus;
a check step of checking contents of data stored in the external memory attached to the printing apparatus;
a determination step of determining a processing operation to be carried out, based on the state of the printing apparatus detected in said detection step and the contents of the data stored in the external memory and checked in said check step, from a plurality of processing operations that can be executed by the printing apparatus using the external memory; and
an execution step of carrying out the processing operation determined in said determination step.

14. A control program for causing a printing apparatus to which an external memory is removably attachable to execute a control method for the printing apparatus,
wherein the control method comprises:
a printing step of printing out print data stored in a storage unit;
a transfer step of transferring, when the print data stored in the storage unit cannot be printed out in said printing step, print data stored in the storage unit and yet to be subjected to print processing into the external memory in response to attachment of the external memory to the printing apparatus; and
an execution step of executing, when the print data stored in the storage unit can be printed out in said printing step, a job using the external memory in response to attachment of the external memory to the printing apparatus.

15. A control program for causing a printing apparatus to which an external memory is removably attachable to execute a control method for the printing apparatus,
wherein the control method comprises:
a detection step of detecting a state of the printing apparatus;
a check step of checking contents of data stored in the external memory attached to the printing apparatus;
a determination step of determining a processing operation to be carried out, based on the state of the printing apparatus detected in said detection step and the contents of the data stored in the external memory and checked in said check step, from a plurality of processing operations that can be executed by the printing apparatus using the external memory; and
an execution step of carrying out the processing operation determined in said determination step.

16. A storage medium storing, in a computer-readably manner, a program for causing a computer to execute a control program for causing a printing apparatus to which an external memory is removably attachable to execute a control method for the printing apparatus,
wherein the control method comprises:
a printing step of printing out print data stored in a storage unit;
a transfer step of transferring, when the print data stored in the storage unit cannot be printed out in said printing step, print data stored in the storage unit and yet to be subjected to print processing into the external memory in response to attachment of the external memory to the printing apparatus; and
an execution step of executing, when the print data stored in the storage unit can be printed out in said printing step, a job using the external memory in response to attachment of the external memory to the printing apparatus.

17. A storage medium storing, in a computer-readably manner, a program for causing a computer to execute a control program for causing a printing apparatus to which an external memory is removably attachable to execute a control method for the printing apparatus,
wherein the control method comprises:
a detection step of detecting a state of the printing apparatus;
a check step of checking contents of data stored in the external memory attached to the printing apparatus,
a determination step of determining a processing operation to be carried out, based on the state of the printing apparatus detected in said detection step and the contents of the data stored in the external memory and checked in said check step, from a plurality of processing operations that can be executed by the printing apparatus using the external memory; and
an execution step of carrying out the processing operation determined in said determination step.
